(19) United States
(12) Patent Application Publication
(10) Pub. No.: US 2024/0334354 A1
(43) Pub. Date: Oct. 3, 2024

(54) MEASUREMENT BASED ON A LOW POWER SIGNAL

(71) Applicant: Samsung Electronics Co., Ltd., Suwon-si (KR)

(72) Inventors: Hongbo Si, Allen, TX (US); Kyeongin Jeong, Allen, TX (US); Shiyang Leng, Allen, TX (US)

(21) Appl. No.: 18/607,057

(22) Filed: Mar. 15, 2024

Related U.S. Application Data
(60) Provisional application No. 63/455,481, filed on Mar. 29, 2023.

(51) Int. Cl. H04W 56/00; H04B 17/318; H04B 17/336; H04L 27/10; H04W 76/28

(52) U.S. Cl. CPC H04W 56/0015; H04B 17/328; H04B 17/336; H04L 27/10; H04W 76/28

(57) ABSTRACT

Apparatuses and methods for measurement based on a low power signal. A method of a user equipment (UE) in a wireless communication system includes determining an On Off Keying (OOK) waveform for a low-power synchronization signal (LP-SS) and determining, based on the LP-SS, at least one of a LP-SS reference signal received power (LP-RSRP), a LP-SS reference signal received quality (LP-RSRQ), a LP-SS received signal strength indicator (LP-RSSI), and a LP-SS signal to noise and interference ratio (LP-SINR). The determined at least one of the LP-RSRP, the LP-RSRQ, the LP-RSSI, and the LP-SINR is based on segments with non-zero values in the OOK waveform of the LP-SS. The method further includes performing a first radio resource management (RRM) measurement based on the LP-SS using a low-power receiver (LR) of the UE.

### CROSS-REFERENCE TO RELATED AND CLAIM OF PRIORITY

The present application claims priority under 35 U.S.C. § 119 (e) to U.S. Provisional Patent Application No. 63/455,481 filed on Mar. 29, 2023, which is hereby incorporated by reference in its entirety.

### TECHNICAL FIELD

The present disclosure relates generally to wireless communication systems and, more specifically, the present disclosure is related to apparatuses and methods for measurement based on a low power signal.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to measurement based on a low power signal.

In one embodiment, a user equipment (UE) in a wireless communication system is provided. The UE includes a transceiver; a low-power receiver (LR); and a processor operably coupled to the transceiver and the LR. The processor is configured to determine an On Off Keying (OOK) waveform for a low-power synchronization signal (LP-SS); and determine, based on the LP-SS, at least one of: a LP-SS reference signal received power (LP-RSRP), a LP-SS reference signal received quality (LP-RSRQ), a LP-SS received signal strength indicator (LP-RSSI), and a LP-SS signal to noise and interference ratio (LP-SINR). The determined at least one of the LP-RSRP, the LP-RSRQ, the LP-RSSI, and the LP-SINR is based on segments with non-zero values in the OOK waveform of the LP-SS. The LR is further configured to perform a first radio resource management (RRM) measurement based on the LP-SS.

In another embodiment, a method of a UE in a wireless communication system is provided. The method includes determining an OOK waveform for a LP-SS and determining, based on the LP-SS, at least one of a LP-RSRP, a LP-RSRQ, a LP-RSSI, and a LP-SINR. The determined at least one of the LP-RSRP, the LP-RSRQ, the LP-RSSI, and the LP-SINR is based on segments with non-zero values in the OOK waveform of the LP-SS. The method further includes performing a first RRM measurement based on the LP-SS using a LR of the UE.

In yet another embodiment, a base station (BS) in a wireless communication system is provided. The BS includes a processor configured to determine an OOK waveform for a LP-SS; and configure a UE to perform a first RRM measurement based on the LP-SS. The first RRM measurement, based on the LP-SS, is at least one of a LP-RSRP, a LP-RSRQ, a LP-RSSI, and a LP-SINR. The LP-RSRP, LP-RSRQ, LP-RSSI, or LP-SINR is based on segments with non-zero values in the OOK waveform of the LP-SS. The BS further includes a transceiver operably coupled to the processor. The transceiver is configured to transmit the LP-SS to the UE.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure; and

FIG. 6 illustrates a flowchart of an example UE procedure for radio resource management (RRM) measurement according to embodiments of the present disclosure.

### DETAILED DESCRIPTION

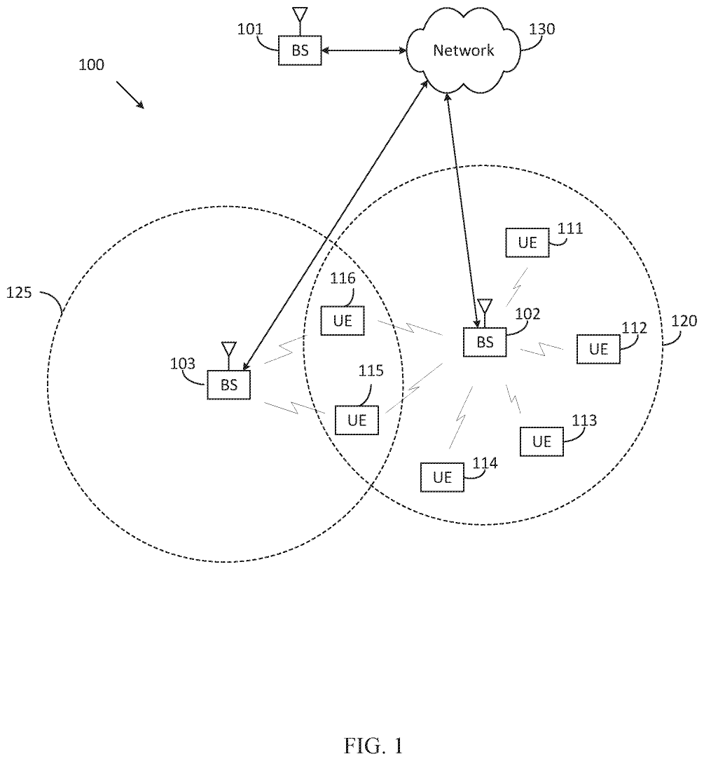

FIGS. 1-6, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.1.0, “NR; Physical channels and modulation;” [2] 3GPP TS 38.212 v17.1.0, “NR; Multiplexing and channel coding;” [3] 3GPP TS 38.213 v17.1.0, “NR; Physical layer procedures for control;” [4] 3GPP TS 38.214 v17.1.0, “NR; Physical layer procedures for data;” and [5] 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for measurement based on a low power signal. In certain embodiments, one or more of the BSs 101-103 include circuitry, programing, or a combination thereof to support measurement based on a low power signal.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

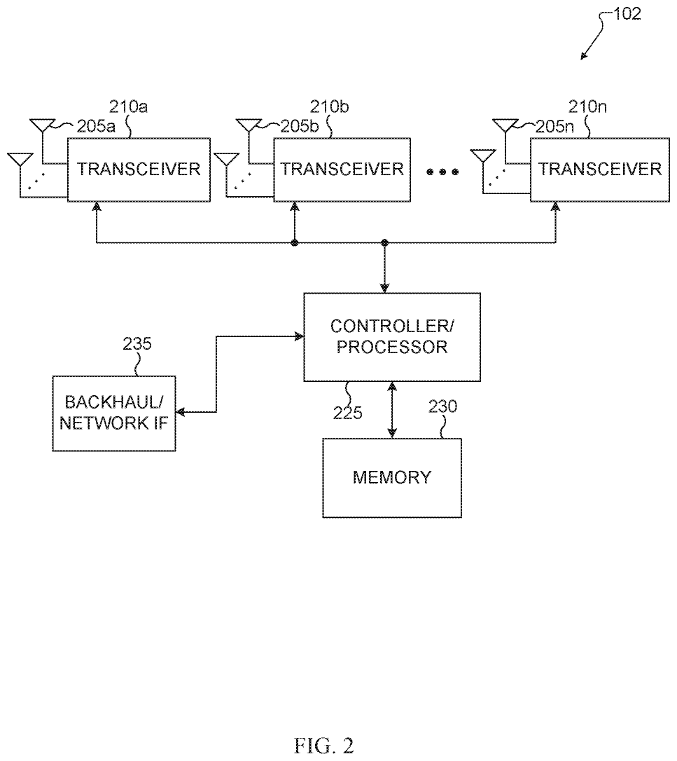

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for measurement based on a low power signal. Any of a wide variety of other functions could be supported in the gNB 102 by the controller/processor 225.

The controller/processor 225 is also capable of executing programs and other processes resident in the memory 230, such as processes to trigger measurement based on a low power signal. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

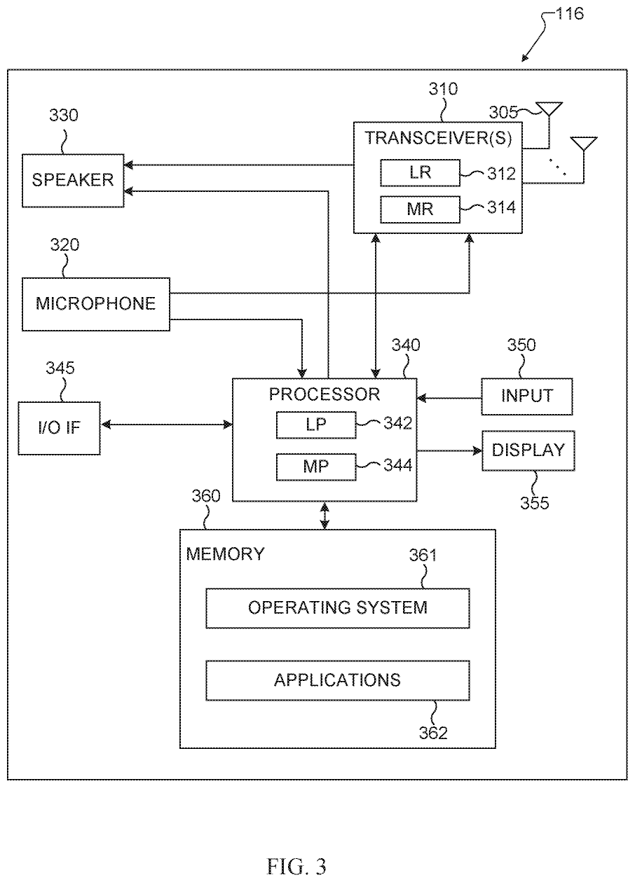

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for measurement based on a low power signal as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

In various embodiments, the transceiver(s) 310 include or are at least one LR 312 and at least one MR 314. For example, as discussed in greater detail below, the LR 312 may be configured or utilized to receive low power signals (e.g., a LP-WUS), for example, when the UE 116 is in a sleep state (e.g., such as an ultra-deep sleep state as discussed in greater detail below), while the MR 314 is powered off or in a low power state. For example, in some embodiments, the LR 312 may be a component of the transceiver(s) 310 used or powered on when the UE 116 is in the sleep state while the MR 314 is the transceiver(s) 310 and used when the UE 116 is not in the sleep state. In another example, in other embodiments, the LR 312 may be receiver that is separate or discrete from the transceivers(s) 310 which is the MR 314 used for ordinary reception operations when the UE 116 is not in the sleep state.

Analogously, in such embodiments, the processor 340 includes or is at least one of the low-power processor (LP) 342 and the main processor (MP) 344. For example, in some embodiments, the LR 312 and the MR 314 may be connected to and/or be controlled by the LP 342 and the MP 344, respectively, which are separate and/or discrete processors. In these embodiments, the LP 342 may operate at a lower power state than the MP 344 such that, when the UE is in the sleep state, the MP 344 may be powered off or in a low power state while the LP 342 can process any signals (e.g., such as a LP-WUS) received by the LR 312. In these embodiments, the operation of the LP 342 may consume less power than ordinary operations of the MP 344 would, thereby saving power of the UE 116 in the sleep state while maintaining the ability of the UE 116 to receive and process signals. In other embodiments, the LP 342 and the MP 344 may be components of the processor 340 where the LR 312 and the MR 314 may be connected to and/or be controlled by the LP 342 and the MP 344, respectively. In these embodiments, when the UE 116 is in the sleep state, MP 344 components of the processor 340 are powered off or in a low power state and LP 342 components operate to process signals (e.g., such as a LP-WUS) received by the LR 312. In these embodiments, the operation of the LP 342 components of the processor 340 may consume less power than ordinary operations of the processor 340 including the operations of the MP 344 components would, thereby saving power of the UE 116 in the sleep state while maintaining the ability of the UE 116 to receive and process signals.

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

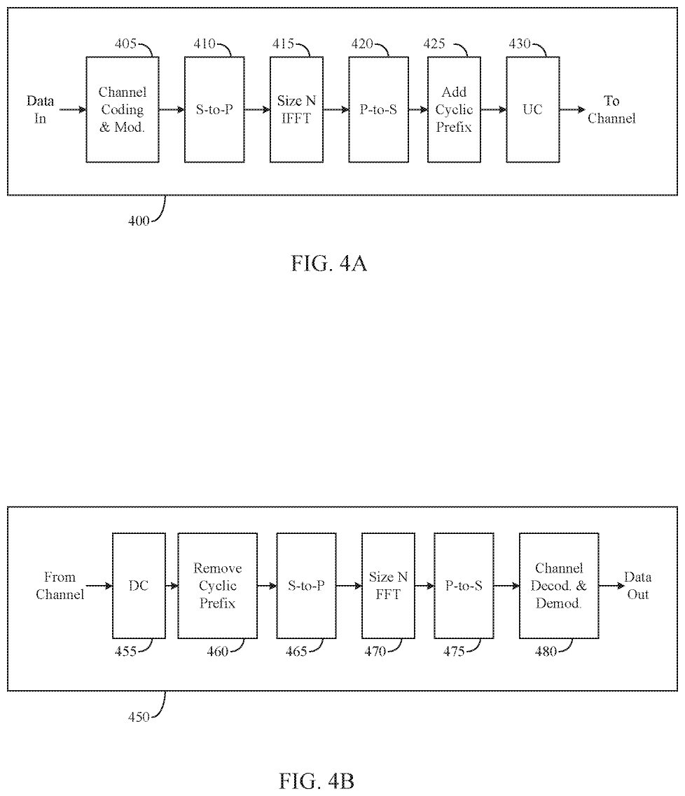

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured for receiving measurement based on a low power signal as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

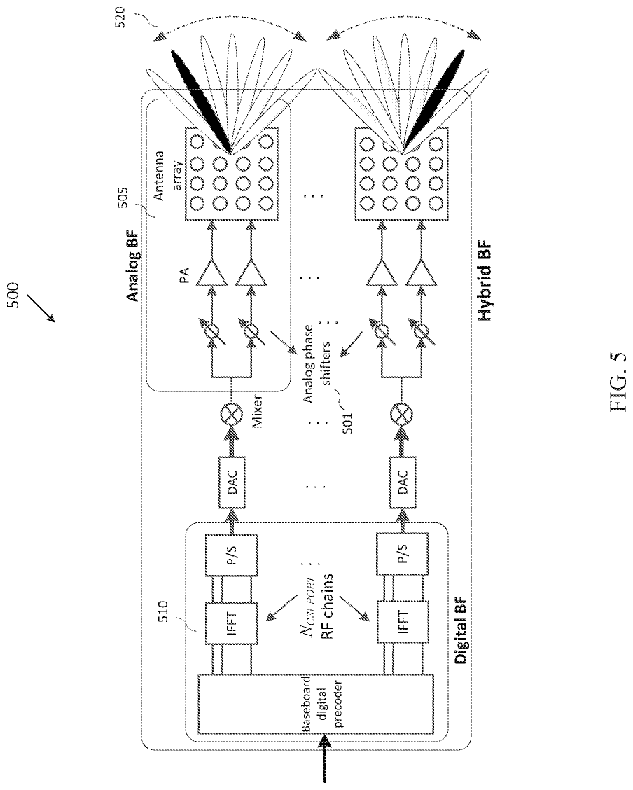

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NGSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

NR supported discontinuous reception (DRX) for a UE in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., connected discontinuous reception (C-DRX) was introduced, wherein a new downlink control information (DCI) format was used to help the UE to skip a ON duration within a C-DRX cycle such that further power saving gain could be achieved. In Rel-17, enhancement towards DRX for RRC_IDLE/RRC_INACTIVE mode (e.g., I-DRX) was introduced, wherein a paging early indication (PEI) was used for a UE to skip monitoring paging occasions such that extra power saving gain could be achieved.

However, embodiments of the present disclosure recognize that the UE still needs to frequently wake up to monitor the new DCI format or the PEI, such that the radio of the UE cannot be fully turned off for a long duration. To avoid such situation and to acquire further power saving gain, an additional receiver radio is evaluated, wherein the additional receiver radio can be used for monitoring a particular set of signals with very low power consumption and the main receiver radio can be turned off or operating with a very lower power for a long duration.

This disclosure focuses on radio resource management measurement based on the low power signal including the metric to be measured based on the low power signal and procedure for the RRM measurement.

For one example, the low power signal can be a signal for synchronization purpose which can be received at least by the low power receiver (e.g., LP-SS), or a signal for waking-up purpose which can be received at least by the low power receiver (e.g., LP-WUS), or the combination of above two signals.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components which can be used in conjunction or in combination with one another or can operate as standalone schemes.

When more than one examples in this disclosure are supported, it can be subject to a higher layer configuration to determine which example the UE follows.

This disclosure focuses on the measurement based on the low power signal. More precisely, the following aspects are included in the disclosure:
Measurement metric based on the low power signal, including LP-reference signal received power (RSRP), LP-received Signal Strength Indicator (RSSI), LP-reference signal received quality (RSRQ), LP-signal to interference and noise ratio (SINR), and LP-reference signal received power per branch (LP-RSRPB),
Measurement window for the low power signal,
Joint measurement between the low power receiver and the main receiver, and
Radio link monitoring based on the low power signal.

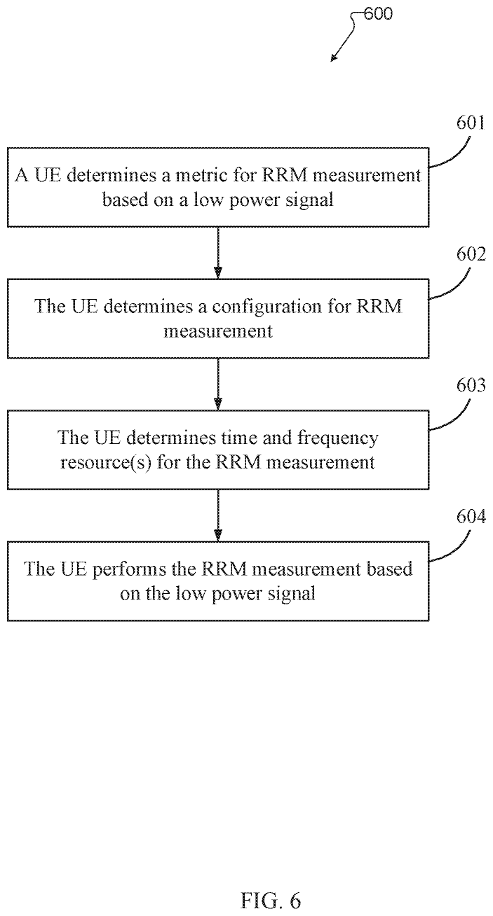

FIG. 6 illustrates a flowchart of an example UE procedure 600 for RRM measurement according to embodiments of the present disclosure. For example, UE procedure 600 for RRM measurement can be performed by any of the UEs 111-116 of FIG. 1. This example is for illustration only and other embodiments can be used without departing from the scope of the present disclosure.

The procedure begins in 601, a UE determines a metric for RRM measurement based on a low power signal. In 602, the UE 116 determines time and frequency resource(s) for the RRM measurement. In 603, the UE 116 determines time and frequency resource(s) for the RRM measurement. In 604, the UE 116 performs the RRM measurement based on the low power signal.

In one embodiment, a UE can perform radio resource management (RRM) measurement based on a low power signal received by a low-power receiver (LR) and determine a reference signal received power (RSRP) of the low power signal, wherein the measurement metric can be denoted as LP-RSRP.

For one example, the LP-RSRP can be defined as the linear average over the power contributions of the resource elements (REs) that carry the low power signal. For one instance, the measurement is performed over the OFDM symbol(s) that carry the low power signal and do not include the cyclic prefix (CP). For one instance, if the LR can receive overlaid sequence for generating the waveform of the low power signal (e.g., configured by the gNB to receive), the LP-RSRP can be over the contributions of the REs that carry the overlaid sequence.

For another example, the LP-RSRP can be defined as the linear average over the power contributions of the resource elements (REs) that are determined or configured to carry the low power signal and include the guard band REs. For one instance, the measurement is performed over the OFDM symbol(s) that carry the low power signal and do not include the CP. For one instance, if the LR can receive overlaid sequence for generating the waveform of the low power signal (e.g., configured by the gNB to receive), the LP-RSRP can be over the contributions of the REs that carry the overlaid sequence.

For yet another example, the LP-RSRP can be defined as the linear average over the power contributions of time durations that are determined to be non-zero values after multi-carrier (MC)-OOK modulation. For one instance, the time durations do not include the CP. In another instance, each time duration corresponds to 1/K OFDM symbol duration (e.g., not including CP), wherein K is the number of segments in a OFDM symbol in MC-OOK modulation. For yet another instance, the power contributions from the bandwidth that includes the low power signal (e.g., potentially with the guard band). For one instance, if the LR can receive overlaid sequence for generating the waveform of the low power signal (e.g., configured by the gNB to receive), the LP-RSRP can be over the contributions of the REs that carry the overlaid sequence.

For yet another example, the LP-RSRP can be defined as the linear average over the power contributions of time durations with MC-OOK modulation. For one instance, the time durations do not include the CP. In another instance, each time duration corresponds to 1/K OFDM symbol duration (e.g., not including CP), wherein K is the number of segments in a OFDM symbol in MC-OOK modulation. For yet another instance, the power contributions from the bandwidth that includes the low power signal (e.g., potentially with the guard band). For one instance, if the LR can receive overlaid sequence for generating the waveform of the low power signal (e.g., configured by the gNB to receive), the LP-RSRP can be over the contributions of the REs that carry the overlaid sequence.

For yet another example, the LP-RSRP can be defined as the linear average over the power contributions of time durations that are determined to be non-zero values after MC-OOK modulation. For one instance, the time durations do not include the CP. In another instance, each time duration corresponds to X/K OFDM symbol duration (e.g., not including CP), wherein K is the number of segments in a OFDM symbol in MC-OOK modulation, and X is a ratio (e.g., a percentage) as the effective range for measurement within one segment for MC-OOK modulation. For yet another instance, the power contributions from the bandwidth that includes the low power signal (e.g., potentially with the guard band). For one instance, if the LR can receive overlaid sequence for generating the waveform of the low power signal (e.g., configured by the gNB to receive), the LP-RSRP can be over the contributions of the REs that carry the overlaid sequence.

For one example, the low power signal can be a signal for synchronization purpose which can be received at least by the low power receiver (e.g., LP-SS) and the corresponding measurement metric can be denoted as LP-SS-RSRP.

For another example, the low power signal can be a signal for waking-up purpose which can be received at least by the low power receiver (e.g., LP-WUS) and the corresponding measurement metric can be denoted as LP-WUS-RSRP.

For yet another example, the low power signal can be the combination of LP-SS and LP-WUS and the corresponding measurement metric is a linear average over the power contributions of both signals.

For one example, the LP-RSRP can be measurement among the signals corresponding to the same physical cell identity or the same group of physical cell identity.

For another example, the LP-RSRP can be measurement among the signals corresponding to the same UE group identity.

For yet another example, the LP-RSRP can be measurement among the signals corresponding to the same UE identity.

For yet another example, the LP-RSRP can be measurement among the signals corresponding to the same quasi co-location (QCL) assumption (e.g., QCLed to the same RS).

For yet another example, the LP-RSRP can be measurement among the signals corresponding to the same transmission configuration indication (TCI) state.

For yet another example, the LP-RSRP can be measurement among the signals corresponding to the same beam index.

For one example, the UE 116 can be provided with higher layer parameters indicating which low power signal(s) within a set of low power signals are measured. For instance, a bitmap indicating which low power signal(s) within a set of low power signals are measured.

For one example, for frequency range 1, the reference point for the LP-RSRP can be the antenna connector of the UE 116.

For another example, for frequency range 2, LP-RSRP can be measured based on the combined signal from antenna elements corresponding to a given receiver branch.

For yet another example, for frequency range 1 and 2, if receiver diversity is in use by the UE 116, the reported LP-RSRP value may not be lower than the corresponding LP-RSRP of any of the individual receiver branches.

For one example, the LP-RSRP can be applicable for RRC_IDLE intra-frequency RRM measurement.

For another example, the LP-RSRP can be applicable for RRC_IDLE inter-frequency RRM measurement.

For yet another example, the LP-RSRP can be applicable for RRC_INACTIVE intra-frequency RRM measurement.

For yet another example, the LP-RSRP can be applicable for RRC_INACTIVE inter-frequency RRM measurement.

For yet another example, the LP-RSRP can be applicable for RRC_CONNECTED intra-frequency RRM measurement.

For yet another example, the LP-RSRP can be applicable for RRC_CONNECTED inter-frequency RRM measurement.

In one embodiment, a UE can perform radio resource management (RRM) measurement based on a low power signal received by a low-power receiver (LR) and determine a received signal strength indicator (RSSI), wherein the measurement metric can be denoted as LP-RSSI.

For one example, the LP-RSSI can be defined as the linear average of the total received power observed in the OFDM symbols of measurement time resource(s), in the measurement bandwidth, over N number of resource blocks from all sources including co-channel serving and non-serving cells, adjacent channel interference, thermal noise, etc. For one instance, the measurement time resource(s) based on the OFDM symbol(s) do not include the CP.

For another example, the LP-RSSI can be defined as the linear average of the total received power observed in the OFDM symbols of measurement time resource(s), in the measurement bandwidth, over N number of resource elements from all sources including co-channel serving and non-serving cells, adjacent channel interference, thermal noise, etc. For one instance, the measurement time resource(s) based on the OFDM symbol(s) do not include the CP.

For one example, the measurement time resource(s) can be configured based on a higher layer configuration.

For another example, the measurement time resource(s) can be without constraints when the higher layer is not provided, e.g., for cell selection.

For yet another example, the measurement time resource(s) can be the OFDM symbols that carry the low power signal (e.g., the OFDM symbols that carry the low power signal can be provided by the higher layer).

For yet another example, the measurement time resource(s) can be time durations that are determined to be non-zero values after MC-OOK modulation of the low power signal. For one instance, the time durations do not include the CP. In another instance, each time duration corresponds to 1/K OFDM symbol duration (e.g., not including CP), wherein K is the number of segments in a OFDM symbol in MC-OOK modulation.

For yet another example, the measurement time resource(s) can be time durations with MC-OOK modulation of the low power signal. For one instance, the time durations do not include the CP. In another instance, each time duration corresponds to 1/K OFDM symbol duration (e.g., not including CP), wherein K is the number of segments in a OFDM symbol in MC-OOK modulation.

For yet another example, the measurement time resource(s) can be time durations that are determined to be non-zero values after MC-OOK modulation. For one instance, the time durations do not include the CP. In another instance, each time duration corresponds to X/K OFDM symbol duration (e.g., not including CP), wherein K is the number of segments in a OFDM symbol in MC-OOK modulation, and X is a ratio (e.g., a percentage) as the effective range for measurement within one segment for MC-OOK modulation.

For one example, the measurement bandwidth at least includes the low power signal (e.g., potentially with the guard band).

For one example, for frequency range 1, the reference point for the LP-RSSI can be the antenna connector of the UE 116.

For another example, for frequency range 2, LP-RSSI can be measured based on the combined signal from antenna elements corresponding to a given receiver branch.

For yet another example, for frequency range 1 and 2, if receiver diversity is in use by the UE 116, the reported LP-RSSI value may not be lower than the corresponding LP-RSSI of any of the individual receiver branches.

For one example, the LP-RSSI can be applicable for RRC_IDLE intra-frequency RRM measurement.

For another example, the LP-RSSI can be applicable for RRC_IDLE inter-frequency RRM measurement.

For yet another example, the LP-RSSI can be applicable for RRC_INACTIVE intra-frequency RRM measurement.

For yet another example, the LP-RSSI can be applicable for RRC_INACTIVE inter-frequency RRM measurement.

For yet another example, the LP-RSSI can be applicable for RRC_CONNECTED intra-frequency RRM measurement.

For yet another example, the LP-RSSI can be applicable for RRC_CONNECTED inter-frequency RRM measurement.

For one example, for intra-frequency measurements, LP-RSSI is measured with timing reference corresponding to the serving cell in the frequency layer.

For another example, for inter-frequency measurements, LP-RSSI is measured with timing reference corresponding to any cell in the target frequency layer.

In one embodiment, a UE can perform radio resource management (RRM) measurement based on a low power signal received by a low-power receiver (LR) and determine a reference signal received quality (RSRQ) of the low power signal, wherein the measurement metric can be denoted as LP-RSRQ.

In one example, the LP-RSRQ can be defined as the ratio of N×LP-RSRP/LP-RSSI, where N is the number of resource blocks in the LP-RSSI measurement bandwidth and the measurements in the numerator and denominator are made over the same set of resource blocks. LP-RSRP and LP-RSSI can be according to examples in this disclosure.

In another example, the LP-RSRQ can be defined as the ratio of NxLP-RSRP/LP-RSSI, where N is the number of resource elements in the LP-RSSI measurement bandwidth and the measurements in the numerator and denominator are made over the same set of resource elements. LP-RSRP and LP-RSSI can be according to examples in this disclosure.

For one example, the low power signal can be a signal for synchronization purpose which can be received at least by the low power receiver (e.g., LP-SS) and the corresponding measurement metric can be denoted as LP-SS-RSRQ.

For another example, the low power signal can be a signal for waking-up purpose which can be received at least by the low power receiver (e.g., LP-WUS) and the corresponding measurement metric can be denoted as LP-WUS-RSRQ.

For yet another example, the low power signal can be the combination of LP-SS and LP-WUS and the corresponding measurement metric is a linear average over the power contributions of both signals.

For one example, the LP-RSRQ can be measurement among the signals corresponding to the same physical cell identity or the same group of physical cell identity.

For another example, the LP-RSRQ can be measurement among the signals corresponding to the same UE group identity.

For yet another example, the LP-RSRQ can be measurement among the signals corresponding to the same UE identity.

For yet another example, the LP-RSRQ can be measurement among the signals corresponding to the same QCL assumption (e.g., QCLed to the same RS).

For yet another example, the LP-RSRQ can be measurement among the signals corresponding to the same TCI state.

For yet another example, the LP-RSRQ can be measurement among the signals corresponding to the same beam index.

For one example, the UE 116 can be provided with a higher layer parameter indicating which low power signal(s) within a set of low power signals are measured. For instance, a bitmap indicating which low power signal(s) within a set of low power signals are measured.

For one example, for frequency range 1, the reference point for the LP-RSRQ can be the antenna connector of the UE 116.

For another example, for frequency range 2, LP-RSRQ can be measured based on the combined signal from antenna elements corresponding to a given receiver branch.

For yet another example, for frequency range 1 and 2, if receiver diversity is in use by the UE 116, the reported LP-RSRQ value may not be lower than the corresponding LP-RSRQ of any of the individual receiver branches.

For one example, the LP-RSRQ can be applicable for RRC_IDLE intra-frequency RRM measurement.

For another example, the LP-RSRQ can be applicable for RRC_IDLE inter-frequency RRM measurement.

For yet another example, the LP-RSRQ can be applicable for RRC_INACTIVE intra-frequency RRM measurement.

For yet another example, the LP-RSRQ can be applicable for RRC_INACTIVE inter-frequency RRM measurement.

For yet another example, the LP-RSRQ can be applicable for RRC_CONNECTED intra-frequency RRM measurement.

For yet another example, the LP-RSRQ can be applicable for RRC_CONNECTED inter-frequency RRM measurement.

In one embodiment, a UE can perform radio resource management (RRM) measurement based on a low power signal received by a low-power receiver (LR) and determine a signal-to-noise and interference ratio (SINR) of the low power signal, wherein the measurement metric can be denoted as LP-SINR.

In one example, the LP-SINR can be defined as of the linear average over the power contribution of the resource elements (REs) carrying the low power signal divided by the linear average of the noise and interference power contribution. For one instance, the noise and interference power contribution are measured over the resource elements carrying the low power signal within the same frequency bandwidth. For another instance, the measurement is performed over the OFDM symbol(s) that carry the low power signal and do not include the CP. For one instance, if the LR can receive overlaid sequence for generating the waveform of the low power signal (e.g., configured by the gNB to receive), the LP-SINR can be over the contributions of the REs that carry the overlaid sequence.

In another example, the LP-SINR can be defined as of the linear average over the power contribution of the resource elements carrying the low power signal and the guard band divided by the linear average of the noise and interference power contribution. For one instance, the noise and interference power contribution are measured over the resource elements carrying the low power signal and the guard band within the same frequency bandwidth. For another instance, the measurement is performed over the OFDM symbol(s) that carry the low power signal and do not include the CP. For one instance, if the LR can receive overlaid sequence for generating the waveform of the low power signal (e.g., configured by the gNB to receive), the LP-SINR can be over the contributions of the REs that carry the overlaid sequence.

For yet another example, the LP-SINR can be defined as the linear average over the power contributions of time durations that are determined to be non-zero values after MC-OOK modulation divided by the linear average of the noise and interference power contribution over the same time durations. For one instance, the noise and interference power contribution are measured over the resource elements carrying the low power signal within the same frequency bandwidth. For another instance, the time durations do not include the CP. For yet another instance, each time duration corresponds to 1/K OFDM symbol duration (e.g., not including CP), wherein K is the number of segments in a OFDM symbol in MC-OOK modulation. For one instance, if the LR can receive overlaid sequence for generating the waveform of the low power signal (e.g., configured by the gNB to receive), the LP-SINR can be over the contributions of the REs that carry the overlaid sequence.

For yet another example, the LP-SINR can be defined as the linear average over the power contributions of time durations with MC-OOK modulation divided by the linear average of the noise and interference power contribution over the same time durations. For one instance, the noise and interference power contribution are measured over the resource elements carrying the low power signal within the same frequency bandwidth. For another instance, the time durations do not include the CP. For yet another instance, each time duration corresponds to 1/K OFDM symbol duration (e.g., not including CP), wherein K is the number of segments in a OFDM symbol in MC-OOK modulation. For one instance, if the LR can receive overlaid sequence for generating the waveform of the low power signal (e.g., configured by the gNB to receive), the LP-SINR can be over the contributions of the REs that carry the overlaid sequence.

For yet another example, the LP-SINR can be defined as the linear average over the power contributions of time durations that are determined to be non-zero values after MC-OOK modulation divided by the linear average of the noise and interference power contribution over the same time durations. For one instance, the noise and interference power contribution are measured over the resource elements carrying the low power signal within the same frequency bandwidth. For another instance, the time durations do not include the CP. In yet another instance, each time duration corresponds to X/K OFDM symbol duration (e.g., not including CP), wherein K is the number of segments in a OFDM symbol in MC-OOK modulation and X is a ratio (e.g., a percentage) as the effective range for measurement within one segment for MC-OOK modulation. For one instance, if the LR can receive overlaid sequence for generating the waveform of the low power signal (e.g., configured by the gNB to receive), the LP-SINR can be over the contributions of the REs that carry the overlaid sequence.

For one example, the low power signal can be a signal for synchronization purpose which can be received at least by the low power receiver (e.g., LP-SS) and the corresponding measurement metric can be denoted as LP-SS-SINR.

For another example, the low power signal can be a signal for waking-up purpose which can be received at least by the low power receiver (e.g., LP-WUS) and the corresponding measurement metric can be denoted as LP-WUS-SINR.

For yet another example, the low power signal can be the combination of LP-SS and LP-WUS and the corresponding measurement metric is a linear average over the power contributions of both signals.

For one example, the LP-SINR can be measurement among the signals corresponding to the same physical cell identity or the same group of physical cell identity.

For another example, the LP-SINR can be measurement among the signals corresponding to the same UE group identity.

For yet another example, the LP-SINR can be measurement among the signals corresponding to the same UE identity.

For yet another example, the LP-SINR can be measurement among the signals corresponding to the same QCL assumption (e.g., QCLed to the same RS).

For yet another example, the LP-SINR can be measurement among the signals corresponding to the same TCI state.

For yet another example, the LP-SINR can be measurement among the signals corresponding to the same beam index.

For one example, the UE 116 can be provided with a higher layer parameter indicating which low power signal(s) within a set of low power signals are measured. For instance, a bitmap indicating which low power signal(s) within a set of low power signals are measured.

For one example, for frequency range 1, the reference point for the LP-SINR can be the antenna connector of the UE 116.

For another example, for frequency range 2, LP-SINR can be measured based on the combined signal from antenna elements corresponding to a given receiver branch.

For yet another example, for frequency range 1 and 2, if receiver diversity is in use by the UE 116, the reported LP-SINR value may not be lower than the corresponding LP-SINR of any of the individual receiver branches.

For one example, the LP-SINR can be applicable for RRC_IDLE intra-frequency RRM measurement.

For another example, the LP-SINR can be applicable for RRC_IDLE inter-frequency RRM measurement.

For yet another example, the LP-SINR can be applicable for RRC_INACTIVE intra-frequency RRM measurement.

For yet another example, the LP-SINR can be applicable for RRC_INACTIVE inter-frequency RRM measurement.

For yet another example, the LP-SINR can be applicable for RRC_CONNECTED intra-frequency RRM measurement.

For yet another example, the LP-SINR can be applicable for RRC_CONNECTED inter-frequency RRM measurement.

In one embodiment, a UE can perform radio resource management (RRM) measurement based on a low power signal received by a low-power receiver (LR) and determine a reference signal received power per branch (RSRPB) of the low power signal, wherein the measurement metric can be denoted as LP-RSRPB.

For one example, the LP-RSRPB can be defined as the linear average over the power contributions of the resource elements (REs) that carry the low power signal. For one instance, the measurement is performed over the OFDM symbol(s) that carry the low power signal and do not include the CP. For one instance, if the LR can receive overlaid sequence for generating the waveform of the low power signal (e.g., configured by the gNB to receive), the LP-RSRPB can be over the contributions of the REs that carry the overlaid sequence.

For another example, the LP-RSRPB can be defined as the linear average over the power contributions of the resource elements (REs) that are configured to carry the low power signal and include the guard band REs. For one instance, the measurement is performed over the OFDM symbol(s) that carry the low power signal and do not include the CP. For one instance, if the LR can receive overlaid sequence for generating the waveform of the low power signal (e.g., configured by the gNB to receive), the LP-RSRPB can be over the contributions of the REs that carry the overlaid sequence.

For yet another example, the LP-RSRPB can be defined as the linear average over the power contributions of time durations that are determined to be non-zero values after MC-OOK modulation. For one instance, the time durations do not include the CP. In another instance, each time duration corresponds to 1/K OFDM symbol duration (e.g., not including CP), wherein K is the number of segments in a OFDM symbol in MC-OOK modulation. For yet another instance, the power contributions from the bandwidth that includes the low power signal (e.g., potentially with the guard band). For one instance, if the LR can receive overlaid sequence for generating the waveform of the low power signal (e.g., configured by the gNB to receive), the LP-RSRPB can be over the contributions of the REs that carry the overlaid sequence.

For yet another example, the LP-RSRPB can be defined as the linear average over the power contributions of time durations with MC-OOK modulation. For one instance, the time durations do not include the CP. In another instance, each time duration corresponds to 1/K OFDM symbol duration (e.g., not including CP), wherein K is the number of segments in a OFDM symbol in MC-OOK modulation. For yet another instance, the power contributions from the bandwidth that includes the low power signal (e.g., potentially with the guard band). For one instance, if the LR can receive overlaid sequence for generating the waveform of the low power signal (e.g., configured by the gNB to receive), the LP-RSRPB can be over the contributions of the REs that carry the overlaid sequence.

For yet another example, the LP-RSRPB can be defined as the linear average over the power contributions of time durations that are determined to be non-zero values after MC-OOK modulation. For one instance, the time durations do not include the CP. In another instance, each time duration corresponds to X/K OFDM symbol duration (e.g., not including CP), wherein K is the number of segments in a OFDM symbol in MC-OOK modulation, and X is a ratio (e.g., a percentage) as the effective range for measurement within one segment for MC-OOK modulation. For yet another instance, the power contributions from the bandwidth that includes the low power signal (e.g., potentially with the guard band). For one instance, if the LR can receive overlaid sequence for generating the waveform of the low power signal (e.g., configured by the gNB to receive), the LP-RSRPB can be over the contributions of the REs that carry the overlaid sequence.

For one example, the low power signal can be a signal for synchronization purpose which can be received at least by the low power receiver (e.g., LP-SS), and the corresponding measurement metric can be denoted as LP-SS-RSRPB.

For another example, the low power signal can be a signal for waking-up purpose which can be received at least by the low power receiver (e.g., LP-WUS) and the corresponding measurement metric can be denoted as LP-WUS-RSRPB.

For yet another example, the low power signal can be the combination of LP-SS and LP-WUS and the corresponding measurement metric is a linear average over the power contributions of both signals.

For one example, the LP-RSRPB can be measurement among the signals corresponding to the same physical cell identity or the same group of physical cell identity.

For another example, the LP-RSRPB can be measurement among the signals corresponding to the same UE group identity.

For yet another example, the LP-RSRPB can be measurement among the signals corresponding to the same UE identity.

For yet another example, the LP-RSRPB can be measurement among the signals corresponding to the same QCL assumption (e.g., QCLed to the same RS).

For yet another example, the LP-RSRPB can be measurement among the signals corresponding to the same TCI state.

For yet another example, the LP-RSRPB can be measurement among the signals corresponding to the same beam index.

For one example, the UE 116 can be provided with a higher layer parameter indicating which low power signal(s) within a set of low power signals are measured. For instance, a bitmap indicating which low power signal(s) within a set of low power signals are measured.

For one example, for frequency range 1, the reference point for the LP-RSRPB can be the antenna connector of the UE 116.

For another example, for frequency range 2, LP-RSRPB can be measured based on the combined signal from antenna elements corresponding to a given receiver branch.

For one example, the LP-RSRPB can be applicable for RRC_IDLE intra-frequency RRM measurement.

For another example, the LP-RSRPB can be applicable for RRC_IDLE inter-frequency RRM measurement.

For yet another example, the LP-RSRPB can be applicable for RRC_INACTIVE intra-frequency RRM measurement.

For yet another example, the LP-RSRPB can be applicable for RRC_INACTIVE inter-frequency RRM measurement.

For yet another example, the LP-RSRPB can be applicable for RRC_CONNECTED intra-frequency RRM measurement.

For yet another example, the LP-RSRPB can be applicable for RRC_CONNECTED inter-frequency RRM measurement.

In one embodiment, at least one measurement time configuration for the low power signal based RRM measurement can be configured by higher layer, e.g., denoted as LP-MTC. For one instance, if the low power signal is a low power synchronization signal, the MTC can be denoted as LP-SMTC or LP-SS-MTC. For another instance, if the low power signal is a low power wake up signal, the MTC can be denoted as LP-WUS-MTC.

For one example, a LP-MTC includes a window periodicity.

For another example, a LP-MTC includes a window duration.

For yet another example, a LP-MTC includes a window offset.

For one example, the measurement time resource(s) for LP-RSRP are confined within the span of the LP-MTC window.

For another example, the measurement time resource(s) for LP-RSSI are confined within the span of the LP-MTC window.

For yet another example, the measurement time resource(s) for LP-RSRQ are confined within the span of the LP-MTC window.

For yet another example, the measurement time resource(s) for LP-SINR are confined within the span of the LP-MTC window.

For yet another example, the measurement time resource(s) for LP-RSRPB are confined within the span of the LP-MTC window.

For one example, if the measurement metric is used for determining a L1-RSRP and/or a L1-SINR, the measurement time resource(s) restriction by the LP-MTC window duration may not be applicable.

For one example, if measurement gap is used, the measurement time resource(s) can be further confined within the overlapped time span between the LP-MTC window and the measurement gap.

For one example, if a DRX operation for the low power receiver is configured, the measurement time resource(s) can be further confined within the overlapped time span between the LP-MTC window and the active time of the DRX periods.

For one example, if a synchronization signal/physical broadcast channels block measurement timing (SMTC) is configured for the main receiver to perform RRM measurement, the measurement time resource(s) for the low power signal based RRM measurement can be a subset of the time measurement time resource(s) determined from the SMTC. For one instance, the periodicity of the LP-MTC can be same as or longer than the periodicity of the SMTC, e.g., as an integer multiple. For another instance, the duration of the LP-MTC can be same as or shorter than the duration of the SMTC.

For another example, if a SMTC is configured for the main receiver to perform RRM measurement the measurement time resource(s) for the low power signal based RRM measurement can be same as the time measurement time resource(s) determined from the SMTC, e.g., the windows from the two measurement time configurations are aligned.

In one embodiment, a UE can perform RRM measurement using both the main receiver (MR) and the low power receiver (LR).

In one example, a UE can determine the RRM measurement metric (e.g., RSRP, RSRQ, RSSI, RSRPB, or SINR) based on both a reference signal received from the MR and the low power signal received by the LR.
For one instance, the reference signal received from the MR can be a Secondary synchronization signal (SSS) in a synchronization signal/physical broadcast channels (SS/PBCH) block (e.g., potentially together with DM-RS of PBCH, for example, by UE implementation) and/or a CSI-RS.
For another instance, the determined RSRP value can be a linear average over all the resource elements carrying both the reference signal received from the MR and the low power signal.
For yet another instance, the low power signal can be received by the MR or the LR in this example.
For yet another instance, the reference signal received from the MR and the low power signal can be QCLed or share the same TCI state.
For yet another instance, there could be a requirement on the measurement time resource(s) between the reference signal received from the MR and the low power signal. For one sub-instance, the measurement time resource(s) for the low power signal can be confined within the window duration determined by the SMTC. For another sub-instance, the measurement time resource(s) for the low power signal can be confined within the same predefined time duration as the measurement time resource(s) for the reference signal received from the MR, wherein the predefined time duration can be a slot, or a subframe, or a frame. For yet another sub-instance, the measurement time resource(s) for the low power signal can overlap within the measurement time resource(s) for the reference signal received from the MR.

In another example, when a UE is performing RRM measurement and evaluating cell selection criterion at least once every determined time duration (e.g., M1*N1 DRX cycle), the UE 116 may be required to perform a number of measurements for filtering, and for each of the measurement for filtering, the UE 116 could use either a reference signal received by the MR (e.g., SSS in SS/PBCH block) or a low power signal (e.g., received by the LR) to perform the measurement.
For one instance, the reference signal received from the MR and the low power signal can be QCLed or share the same TCI state.
For yet another instance, there could be a requirement on the measurement time resource(s) between the reference signal received from the MR and the low power signal. For one sub-instance, the measurement time resource(s) for the low power signal can be confined within the window duration determined by the SMTC. For another sub-instance, the measurement time resource(s) for the low power signal can be confined within the same predefined time duration as the measurement time resource(s) for the reference signal received from the MR, wherein the predefined time duration can be a slot, or a subframe, or a frame. For yet another sub-instance, the measurement time resource(s) for the low power signal can overlap within the measurement time resource(s) for the reference signal received from the MR.
For yet another instance, the low power signal (e.g., received by the LR) can be used to perform the measurement when the MR is turned off or turned to a deep sleep mode.
For yet another instance, when the low power signal (e.g., received by the LR) is used to perform the measurement (e.g., gNB provides a configuration on RRM measurement based on the low power signal), the requirement on the number of samples to be measured using the MR can be relaxed (e.g., reduced to a smaller number).

In one embodiment, with reference to FIG. 6, an example UE procedure for performing RRM measurement based on a low power signal is shown.

In one embodiment, a UE can monitor a downlink radio link quality of a primary cell or a primary secondary cell (PSCell) for the purpose of indicating out-of-sync or in-sync status to higher layers, wherein the radio link monitoring can be based on a low power signal.

For one example, the UE 116 is not required to monitor the downlink radio link quality in a DL bandwidth part (BWP) other than the active DL BWP on the PCell or PSCell.

For another example, the UE 116 is not required for monitor the downlink radio link quality in a DL BWP other than the DL BWP that includes the low power signal when the radio link monitoring (RLM) is based on the low power signal.

For yet another example, the UE 116 is not required for monitor the downlink radio link quality in a bandwidth other than the bandwidth carrying the low power signal (e.g., including the guard band) when the RLM is based on the low power signal.

For one example, the UE 116 can be configured to use the low power signal for RLM purpose (e.g., provided by a higher layer parameter).

For another example, the UE 116 can determine to use the low power signal for RLM purpose when the low power signal is configured and/or the main receiver is turned off or turned into a deep sleep mode.

For one example, the UE 116 can be configured with a set of resource indexes by a higher layer parameter for RLM, wherein the resource is for the low power signal.
For one instance, there can be a maximum value (M) for the number of resource indexes, wherein the maximum value can be determined based on Lₘₐₓ (e.g., the maximum number of SS/PBCH block index in a cell). For one sub-instance, M=2 when Lₘₐₓ=4. For another sub-instance, M=4 when Lₘₐₓ=8. For yet another sub-instance, M=8 when Lₘₐₓ=64. For yet another sub-instance, M=1 when Lₘₐₓ=4. For another sub-instance, M=2 when Lₘₐₓ=8. For yet another sub-instance, M=4 when Lₘₐₓ=64.
For another instance, the number of resource indexes in the set can be fixed as 1.

For one example, when the UE 116 is configured with DRX operation for the low power receiver, the UE 116 performs the radio link quality evaluation over a period against out-of-sync and in-sync thresholds, wherein the period can be a maximum value between a shortest periodicity for RLM and the DRX period.

For another example, when the UE 116 is not configured with DRX operation for the low power receiver, the UE 116 performs the radio link quality evaluation over a period against out-of-sync and in-sync thresholds, wherein the period can be a maximum value between a shortest periodicity for RLM and a predefined time duration. For instance, the predefined time duration can be 10 ms.

For one example, the out-of-sync and/or in-sync thresholds can be associated with the low power receiver and separately configured from the out-of-sync and/or in-sync thresholds used by the main receiver for RLM evaluation.

For one example, when the radio link quality is worse than the out-of-sync threshold for all resources in the set of resources for radio link monitoring, the UE 116 reports out-of-sync to higher layers.

For another example, when the radio link quality is better than the in-sync threshold for any resource in the set of resources for radio link monitoring, the UE 116 reports in-sync to higher layers.

In one example, the in-sync/out-of-sync evaluation can be based on the detection accuracy rate of the low power signal.

In another example, the in-sync/out-of-sync evaluation can be based on the non-false-alarm rate of the low power signal.

In one example, when a UE is performing RLM, the UE 116 may be required to perform a number of evaluations per a period and, for each of the evaluation, the UE 116 could use either a reference signal received by the MR (e.g., SS/PBCH block or CSI-RS) or a low power signal (e.g., received by the LR) to perform the evaluation.
For one instance, the reference signal received from the MR and the low power signal can be QCLed or share the same TCI state.
For yet another instance, there could be a requirement on the time resource(s) between the reference signal received from the MR and the low power signal. For one sub-instance, the time resource(s) for the low power signal can be confined within the window duration determined by the SMTC. For another sub-instance, the time resource(s) for the low power signal can be confined within the same predefined time duration as the time resource(s) for the reference signal received from the MR, wherein the predefined time duration can be a slot, or a subframe, or a frame. For yet another sub-instance, the time resource(s) for the low power signal can overlap within the time resource(s) for the reference signal received from the MR.
For yet another instance, the low power signal (e.g., received by the LR) can be used to perform the evaluation when the MR is turned off or turned to a deep sleep mode.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver;
a low-power receiver (LR); and
a processor operably coupled to the transceiver and the LR, the processor configured to:
determine an On Off Keying (OOK) waveform for a low-power synchronization signal (LP-SS); and
determine, based on the LP-SS, at least one of:
a LP-SS reference signal received power (LP-RSRP),
a LP-SS reference signal received quality (LP-RSRQ),
a LP-SS received signal strength indicator (LP-RSSI), and
a LP-SS signal to noise and interference ratio (LP-SINR),
wherein the determined at least one of the LP-RSRP, the LP-RSRQ, the LP-RSSI, and the LP-SINR is based on segments with non-zero values in the OOK waveform of the LP-SS; and
wherein the LR is further configured to perform a first radio resource management (RRM) measurement based on the LP-SS.

2. The UE of claim 1, wherein the UE is in RRC_IDLE or RRC_INACTIVE state for the first RRM measurement.

3. The UE of claim 1, wherein:
the transceiver is further configured to receive higher layer parameters;
the processor is further configured to determine, based on the higher layer parameters, a first RRM measurement window for the LP-SS, and
time domain resources of LP-SS used for the first RRM measurement are within the first RRM measurement window.

4. The UE of claim 3, wherein the processor is further configured to:
determine a discontinuous reception (DRX) operation for the LR; and
determine that the time domain resources of LP-SS used for the first RRM measurement are within an overlapping time span between the first RRM measurement window and an active period of the DRX operation.

5. The UE of claim 3, wherein the processor is further configured to:
determine a measurement timing configuration based on a synchronization signals and physical broadcast channel (SS/PBCH) block (SMTC) for the transceiver;
determine, based on the SMTC, a second RRM measurement window for SS/PBCH block; and
determine the first RRM measurement window as a subset of the second RRM measurement window.

6. The UE of claim 1, wherein:
the transceiver is further configured to perform a second RRM measurement based on a reference signal (RS); and
the processor is further configured to:
determine a number of measurements within a pre-defined time duration; and
select a measurement in the number of measurements from (i) the second RRM measurement by the transceiver based on the RS or (ii) the first RRM measurement by the LR based on the LP-SS.

7. The UE of claim 6, wherein the RS is a secondary synchronization signal (SSS) in a synchronization signals and physical broadcast channel (SS/PBCH) block.

8. A method of a user equipment (UE) in a wireless communication system, the method comprising:
determining an On Off Keying (OOK) waveform for a low-power synchronization signal (LP-SS);
determining, based on the LP-SS, at least one of:
a LP-SS reference signal received power (LP-RSRP),
a LP-SS reference signal received quality (LP-RSRQ),
a LP-SS received signal strength indicator (LP-RSSI), and
a LP-SS signal to noise and interference ratio (LP-SINR),
wherein the determined at least one of the LP-RSRP, the LP-RSRQ, the LP-RSSI, and the LP-SINR is based on segments with non-zero values in the OOK waveform of the LP-SS; and
performing a first radio resource management (RRM) measurement based on the LP-SS using a low-power receiver (LR) of the UE.

9. The method of claim 8, wherein the UE is in RRC_IDLE or RRC_INACTIVE state for the first RRM measurement.

10. The method of claim 8, further comprising:
receiving higher layer parameters; and
determining, based on the higher layer parameters, a first RRM measurement window for the LP-SS,
wherein time domain resources of LP-SS used for the first RRM measurement are within the first RRM measurement window.

11. The method of claim 10, further comprising:
determining a discontinuous reception (DRX) operation for the LR; and
determining that the time domain resources of LP-SS used for the first RRM measurement are within an overlapping time span between the first RRM measurement window and an active period of the DRX operation.

12. The method of claim 10, further comprising:
determining a measurement timing configuration based on a synchronization signals and physical broadcast channel (SS/PBCH) block (SMTC) for a transceiver; and
determining, based on the SMTC, a second RRM measurement window for SS/PBCH block,
wherein the first RRM measurement window is a subset of the second RRM measurement window.

13. The method of claim 8, further comprising:
performing a second RRM measurement based on a reference signal (RS) by a transceiver of the UE;
determining a number of measurements within a pre-defined time duration; and
selecting a measurement in the number of measurements from (i) the second RRM measurement by the transceiver based on the RS or (ii) the first RRM measurement by the LR based on the LP-SS.

14. The method of claim 13, wherein the RS is a secondary synchronization signal (SSS) in a synchronization signals and physical broadcast channel (SS/PBCH) block.

15. A base station (BS) in a wireless communication system, the BS comprising:
a processor configured to:
determine an On Off Keying (OOK) waveform for a low-power synchronization signal (LP-SS); and
configure a user equipment (UE) to perform a first radio resource management (RRM) measurement based on the LP-SS, wherein:
the first RRM measurement, based on the LP-SS, is at least one of:
a LP-SS reference signal received power (LP-RSRP),
a LP-SS reference signal received quality (LP-RSRQ),
a LP-SS received signal strength indicator (LP-RSSI), and
a LP-SS signal to noise and interference ratio (LP-SINR), and
the LP-RSRP, LP-RSRQ, LP-RSSI, or LP-SINR is based on segments with non-zero values in the OOK waveform of the LP-SS; and
a transceiver operably coupled to the processor, the transceiver configured to transmit the LP-SS to the UE.

16. The BS of claim 15, wherein:
the transceiver is further configured to transmit higher layer parameters indicating a first RRM measurement window for the LP-SS, and
time domain resources of LP-SS used for the first RRM measurement are within the first RRM measurement window.

17. The BS of claim 16, wherein the processor is further configured to:
configure a discontinuous reception (DRX) operation for a low-power receiver of the UE; and
determine that the time domain resources of LP-SS used for the first RRM measurement are within an overlapping time span between the first RRM measurement window and an active period of the DRX operation.

18. The BS of claim 16, wherein the processor is further configured to:
configure a measurement timing configuration based on a synchronization signals and physical broadcast channel (SS/PBCH) block (SMTC);
determine, based on the SMTC, a second RRM measurement window for SS/PBCH block; and
determine the first RRM measurement window as a subset of the second RRM measurement window.

19. The BS of claim 15, wherein:
the processor is further configured to configure the UE to perform a second RRM measurement based on a reference signal (RS); and
selection of a measurement in a number of measurements within a pre-defined time duration are from (i) the second RRM measurement based on the RS or (ii) the first RRM measurement based on the LP-SS.

20. The BS of claim 19, wherein the RS is a secondary synchronization signal (SSS) in a synchronization signals and physical broadcast channel (SS/PBCH) block.
